(19) United States
(12) Patent Application Publication
(10) Pub. No.: US 2013/0293330 A1
(43) Pub. Date: Nov. 7, 2013

(54) MAGNETIC DEVICE HAVING THERMALLY-CONDUCTIVE BOBBIN

(71) Applicants: Chen-Feng Wu, Taoyuan Hsien (TW); Ya-Ling Chung Hou, Taoyuan Hsien (TW)

(72) Inventors: Chen-Feng Wu, Taoyuan Hsien (TW); Ya-Ling Chung Hou, Taoyuan Hsien (TW)

(73) Assignee: DELTA ELECTRONICS, INC., Taoyuan Hsien (TW)

(21) Appl. No.: 13/614,736

(22) Filed: Sep. 13, 2012

(30) Foreign Application Priority Data
May 7, 2012 (TW) 101116247

(51) Int. Cl. H01F 27/08

(52) U.S. Cl. 336/61

(57) ABSTRACT

A magnetic device includes a thermally-conductive bobbin and a winding coil. The thermally-conductive bobbin has a winding section. The winding coil is wound around the winding section. The heat generated from the winding coil is dissipated away through the thermally-conductive bobbin.

### FIELD OF THE INVENTION

The present invention relates to a magnetic device, and more particularly to a magnetic device with a thermally-conductive bobbin.

### BACKGROUND OF THE INVENTION

An electrical appliance is usually equipped with various magnetic devices such as transformers or inductors. As the electrical appliance is developed toward miniaturization, the sizes of the magnetic devices and the inner components are gradually reduced in order to enhance the space utilization of the circuit board. During operation of the electrical appliance, the electronic components may generate energy in the form of heat. Since the size of the magnetic device is reduced, it is very important to remove the heat. If no proper heat-dissipating mechanism is provided to transfer enough heat to the ambient air, the elevated operating temperature may deteriorate the operating performance, reduce the reliability and shorten the use life of the magnetic device.

FIG. 1 is a schematic perspective view illustrating the structure of a conventional magnetic device. As shown in FIG. 1, the conventional magnetic device 1 includes a bobbin 10, a winding coil 11, a magnetic core assembly 12, and a heat-dissipating plate 13. The winding coil 11 is wound around the bobbin 10. The magnetic core assembly 12 is at least partially embedded within the bobbin 10. The bobbin 10 with the winding coil 11 is clamped by the heat-dissipating plate 13, and the magnetic core assembly 12 is partially sheltered by the heat-dissipating plate 13. The resulting structure of the assembled magnetic device 1 is shown in FIG. 1.

During operation of the magnetic device 1, the winding coil 11 and the magnetic core assembly 12 may generate energy in the form of heat, which is readily accumulated within the magnetic device 1. Consequently, the operating temperature of the magnetic device 1 is increased. Moreover, since the heat-dissipating plate 13 is attached on the outer surfaces of the winding coil 11 and the magnetic core assembly 12, the heat-dissipating plate 13 is only able to dissipate the heat from the outer surfaces of the winding coil 11 and the magnetic core assembly 12. That is, the heat from the inner surfaces of the winding coil 11 of the bobbin 10 and the magnetic core assembly 12 fails to be effectively removed by the heat-dissipating plate 13. If no proper heat-dissipating mechanism is provided to transfer enough heat from the inner portion of the magnetic device 1 to the ambient air, the operating temperature is increased. Moreover, as the operating temperature of the magnetic device 1 is increased, the saturation flux density (Bs) of the magnetic core assembly 12 is decreased. Consequently, the operating performance and the electrical safety of the power circuit are both adversely affected. In addition, the magnetic device 1 has reduced operating efficiency, reduced reliability and shortened use life. For avoiding the problem of the elevated operating temperature, a larger magnetic core assembly 12 may be employed to increase the heat-dissipating efficacy and increase the operating performance of the magnetic device 1. However, since the overall volume of the magnetic device 1 is increased, the purpose of minimizing the magnetic device 1 fails to be achieved.

Therefore, there is a need of providing a magnetic device with a thermally-conductive bobbin in order to eliminate the above drawbacks.

### SUMMARY OF THE INVENTION

The present invention provides a magnetic device with a thermally-conductive bobbin. The thermally-conductive bobbin is effective to dissipate the heat from inner surfaces of the winding coil and the magnetic core assembly. Consequently, the operating temperature of the magnetic device is largely reduced. When compared with the conventional magnetic device having the external heat-dissipating plate, the magnetic device of the present invention has enhanced operating performance, better reliability and longer use life. In addition, the overall volume of the magnetic device is reduced so that the purpose of minimizing the magnetic device can be achieved.

In accordance with an aspect of the present invention, there is provided a magnetic device. The magnetic device includes a thermally-conductive bobbin and a winding coil. The thermally-conductive bobbin has a winding section. The winding coil is wound around the winding section. The heat generated from the winding coil is dissipated away through the thermally-conductive bobbin.

In an embodiment, the magnetic device further comprises a magnetic core assembly. The magnetic core assembly is at least partially embedded within a channel of the thermally-conductive bobbin.

In an embodiment, the thermally-conductive bobbin has a non-seamless ring-shape. Alternatively, the thermally-conductive bobbin is formed by at least two parts having corresponding profiles with each other.

In an embodiment, the thermally-conductive bobbin further comprises a heat-dissipating plate. The heat-dissipating plate is fixed on an inner wall of the thermally-conductive bobbin.

In an embodiment, the magnetic device further comprises an insulating medium. The insulating medium is formed on a surface of the thermally-conductive bobbin, and/or the insulating medium is arranged between the thermally-conductive bobbin and the winding coil, and/or the insulating medium is formed on a surface of the winding coil.

In an embodiment, the magnetic device further comprises a fixing structure, which is extended from the thermally-conductive bobbin. Through the fixing structure, the magnetic device is fixed on a system board.

In an embodiment, a thermal conductivity of the thermally-conductive bobbin is 10 W/m×K or higher than 10 W/m×K.

In accordance with another aspect of the present invention, there is provided a magnetic device. The magnetic device includes a first thermally-conductive bobbin, a first winding coil, a second thermally-conductive bobbin, and a second winding coil. The first thermally-conductive bobbin has a first channel. The first winding coil is wound around the first thermally-conductive bobbin. The second thermally-conductive bobbin has a second channel. The second winding coil is wound around the second thermally-conductive bobbin.

In an embodiment, the magnetic device further comprises a magnetic core assembly. The second thermally-conductive bobbin is accommodated within the first channel of the first thermally-conductive bobbin. The magnetic core assembly is at least partially embedded within the second channel of the second thermally-conductive bobbin.

In an embodiment, the magnetic device further comprises a magnetic core assembly. The first thermally-conductive bobbin and the second thermally-conductive bobbin are arranged in a side-by-side manner. A part of the magnetic core assembly is at least partially embedded within the first channel of the first thermally-conductive bobbin, and another part of the magnetic core assembly is at least partially embedded within the second channel of the second thermally-conductive bobbin.

In an embodiment, a thermal conductivity of the first thermally-conductive bobbin is 10 W/m×K or higher than 10 W/m×K. A thermal conductivity of the second thermally-conductive bobbin is 10 W/m×K or higher than 10 W/m×K.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the structure of a conventional magnetic device;

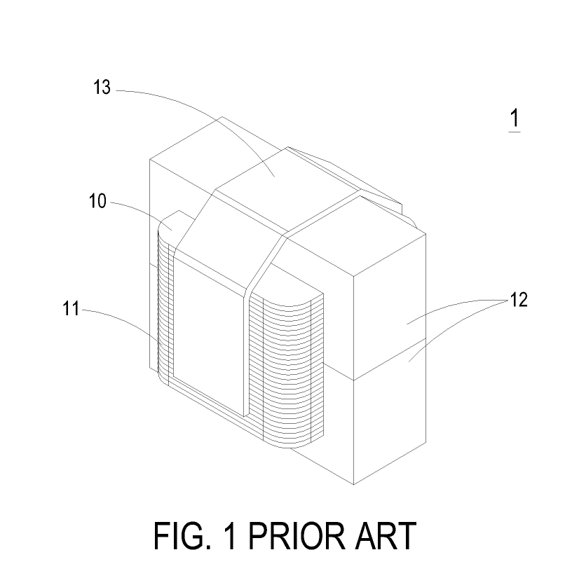

FIG. 2A is a schematic exploded view illustrating a magnetic device according to a first embodiment of the present invention;

FIG. 2B is a schematic assembled view illustrating the magnetic device of FIG. 2A;

FIG. 2C is a schematic perspective view illustrating an exemplary thermally-conductive bobbin used in the magnetic device of FIG. 2A, in which the thermally-conductive bobbin is coated with an insulating medium;

FIG. 2D is a schematic perspective view illustrating another exemplary thermally-conductive bobbin used in the magnetic device of FIG. 2A, in which the thermally-conductive bobbin has a fixing structure;

FIG. 3 is a schematic assembled view illustrating a thermally-conductive bobbin and a winding coil of a magnetic device according to a second embodiment of the present invention;

FIG. 4 is a schematic cross-sectional view illustrating a magnetic device according to a third embodiment of the present invention; and

FIG. 5 is a schematic cross-sectional view illustrating a magnetic device according to a fourth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

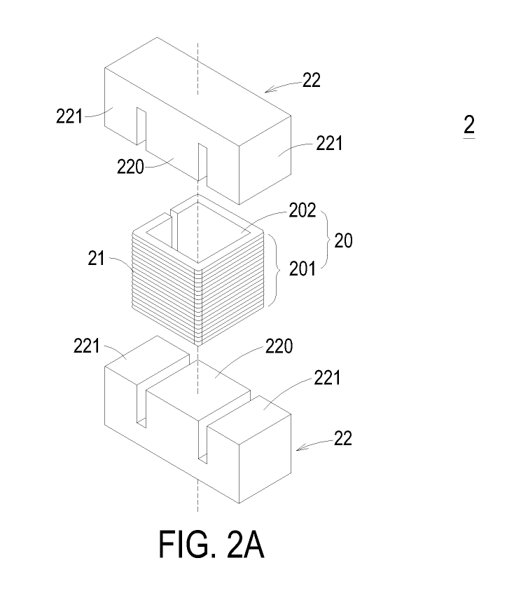

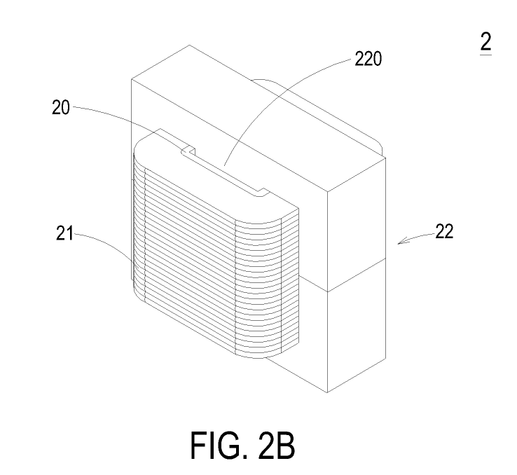

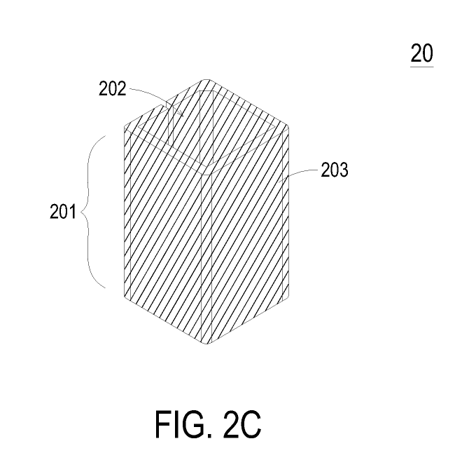

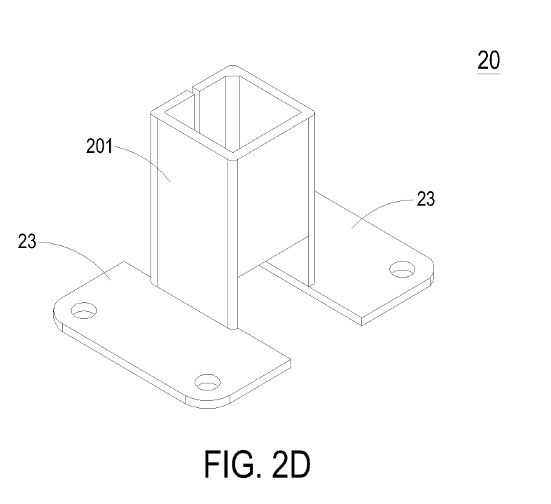

FIG. 2A is a schematic exploded view illustrating a magnetic device according to a first embodiment of the present invention. FIG. 2B is a schematic assembled view illustrating the magnetic device of FIG. 2A. An example of the magnetic device 2 includes but is not limited to a transformer, an inductor, a filter, or the like. As shown in FIG. 2A, the magnetic device 2 includes a thermally-conductive bobbin 20, a winding coil 21, and a magnetic core assembly 22. The thermally-conductive bobbin 20 has a winding section 201 and a channel 202. The winding coil 21 is wound around the winding section 201. The magnetic core assembly 22 is at least partially embedded within the channel 202. After the magnetic device 2 is assembled, the heat from the winding coil 21 and the magnetic core assembly 22 may be dissipated away through the thermally-conductive bobbin 20. In this embodiment, the thermally-conductive bobbin 20 can be a one-piece part, but it is not limited thereto.

Please refer to FIGS. 2A and 2B again. For enhancing the heat-dissipating efficiency, the thermal conductivity of the thermally-conductive bobbin 20 is 10 W/m×K or higher. For example, the thermally-conductive bobbin 20 is made of a thermally-conductive material. The thermal conductivity of the thermally-conductive material is 10 W/m×K or higher. In some embodiments, the thermally-conductive bobbin 20 is made of a metallic material such as copper, aluminum or iron. In a case that the thermally-conductive bobbin 20 is made of the metallic material, the thermally-conductive bobbin 20 has a non-seamless ring-shape. Since the thermally-conductive bobbin 20 is made of metal, the structural strength of the magnetic device 2 is enhanced. Under this circumstance, the thermally-conductive bobbin 20 further has the function of structurally supporting the magnetic device 2.

In some embodiments, the thermally-conductive bobbin 20 is made of a non-metallic material such as a carbon fiber material, a composite material or a ceramic material. In a case that the thermally-conductive bobbin 20 is made of the non-metallic material, the thermally-conductive bobbin 20 is a seamless ring-shaped plate.

Please refer to FIG. 2A again. The magnetic device 2 further includes a magnetic core assembly 22. The magnetic core assembly 22 is at least partially embedded within the channel 202 of the thermally-conductive bobbin 20 for conducting the magnetic flux. In this embodiment, the magnetic core assembly 22 is an EE-type magnetic core assembly. The magnetic core assembly 22 includes two E cores, wherein each E core includes a middle post 220 and two lateral posts 221. The two lateral posts 221 are located at bilateral sides of the middle post 220. In some other embodiments, the winding coil 21 is wound as a winding assembly, and the winding assembly is directly sheathed around the winding section 201. For assembling the magnetic device 2, the winding coil 21 is firstly wound around the winding section 201 of the thermally-conductive bobbin 20. After the winding coil 21 and the thermally-conductive bobbin 20 are combined together, the middle posts 220 of the magnetic core assembly 22 are embedded within the channel 202 of the thermally-conductive bobbin 20. The resulting structure of the assembled magnetic device 2 is shown in FIG. 2B. Of course, the magnetic core assembly 22 is not limited to the EE-type magnetic core assembly as long as the magnetic core assembly 22 is at least partially embedded within the channel 202 of the thermally-conductive bobbin 20. It is noted that numerous modifications and alterations of the magnetic core assembly 22 may be made while retaining the teachings of the invention.

FIG. 2C is a schematic perspective view illustrating an exemplary thermally-conductive bobbin used in the magnetic device of FIG. 2A, in which the thermally-conductive bobbin is coated with an insulating medium. As shown in FIG. 2C, the magnetic device 2 further includes an insulating medium 203. The insulating medium 203 is sprayed on the surface of the thermally-conductive bobbin 20. That is, the insulating medium 203 is arranged between the thermally-conductive bobbin 20 and the winding coil 21 in order to insulate the thermally-conductive bobbin 20 from the winding coil 21. Alternatively, in some embodiments, the insulating medium 203 is directly formed on the surface of the thermally-conductive bobbin 20 by an injection molding process. Alternatively, in some embodiments, the insulating medium 203 is formed on the winding section 201 of the thermally-conductive bobbin 20 only. That is, the surface of the thermally-conductive bobbin 20 is not completely covered by the insulating medium 203. From the above discussions, the insulating medium 203 is formed on a surface of the thermally-conductive bobbin 20 or the insulating medium 203 is arranged between the thermally-conductive bobbin 20 and the winding coil 21, so that the insulation between the thermally-conductive bobbin 20 and the winding coil 21 is achieved through the insulating medium 203.

Alternatively, in some other embodiments, the insulating medium 203 is directly formed on the surface of the winding coil 21. That is, the winding coil 21 is covered by the insulating medium 203. After the winding coil 21 with the insulating medium 203 is wound around the winding section 201 of the thermally-conductive bobbin 20, the insulation between the thermally-conductive bobbin 20 and the winding coil 21 is achieved through the insulating medium 203.

FIG. 2D is a schematic perspective view illustrating another exemplary thermally-conductive bobbin used in the magnetic device of FIG. 2A, in which the thermally-conductive bobbin has a fixing structure. As shown in FIG. 2D, the thermally-conductive bobbin 20 has a fixing structure 23. The fixing structure 23 is extended from a bottom part of the thermally-conductive bobbin 20. In addition, the fixing structure 23 is perpendicular to the winding section 201 of the thermally-conductive bobbin 20. Through the fixing structure 23, the magnetic device 2 may be fixed on a system board (not shown) by fastening, screwing, engaging or welding means.

After the magnetic device 2 is assembled, the heat from the winding coil 21 and the magnetic core assembly 22 may be dissipated away through the thermally-conductive bobbin 20. As a consequence, the heat-dissipating efficacy is enhanced. In addition to the function of proving a winding section for winding coil and enhancing the heat-dissipating efficacy, the thermally-conductive bobbin 20 is effective to structurally support the magnetic device 2. Moreover, since the bobbin used in the conventional magnetic device is omitted according to the present invention, the material cost of the present magnetic device is reduced. Moreover, since the operating temperature of the magnetic device 2 is largely reduced, the reliability and the use life of the magnetic device 2 are both increased. Since the magnetic properties of the magnetic core assembly 22 are enhanced, the size of the magnetic core assembly 22 may be reduced while maintaining the operating performance of the magnetic device 2. Under this circumstance, the overall volume of the magnetic device 2 is decreased, and the material cost is reduced.

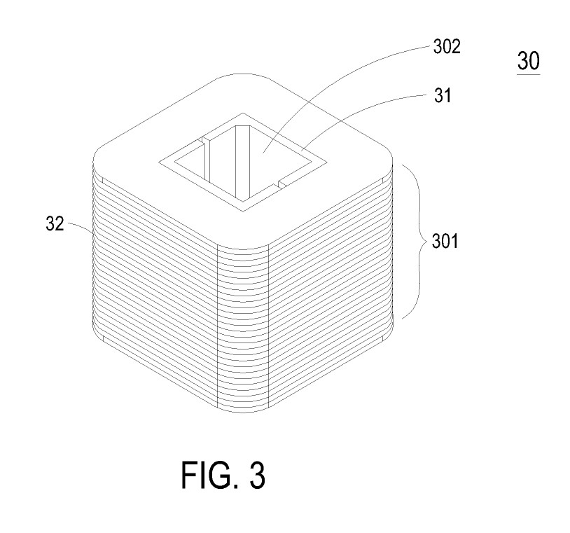

FIG. 3 is a schematic assembled view illustrating a thermally-conductive bobbin and a winding coil of a magnetic device according to a second embodiment of the present invention. The thermally-conductive bobbin 30 includes at least one heat-dissipating plate 31, a winding section 301, and a channel 302. The configurations of the winding section 301 and the channel 302 are similar to those of FIG. 2, and are not redundantly described herein. In this embodiment, the thermally-conductive bobbin 30 further includes the heat-dissipating plate 31. The heat-dissipating plate 31 is fixed on an inner wall of the thermally-conductive bobbin 30. In this embodiment, the thermally-conductive bobbin 30 has two heat-dissipating plates 31, which are arranged around the channel 302 for removing the heat from the winding coil 32 and the magnetic core assembly (not shown). It is noted that the number of the heat-dissipating plates 31 may be varied according to the practical requirements. Alternatively, the heat-dissipating plate 31 can be a one-piece part.

From the above discussions, the thermally-conductive bobbin of the present invention is able to dissipate the heat of the magnetic device. Consequently, the overall heat-dissipating efficacy is enhanced. Moreover, since it is not necessary to install an additional heat-dissipating structure outside the magnetic device, the overall volume of the magnetic device may be reduced. Moreover, the turns of the winding coil may be increased according to the practical requirement in order to enhance the operating performance of the magnetic device.

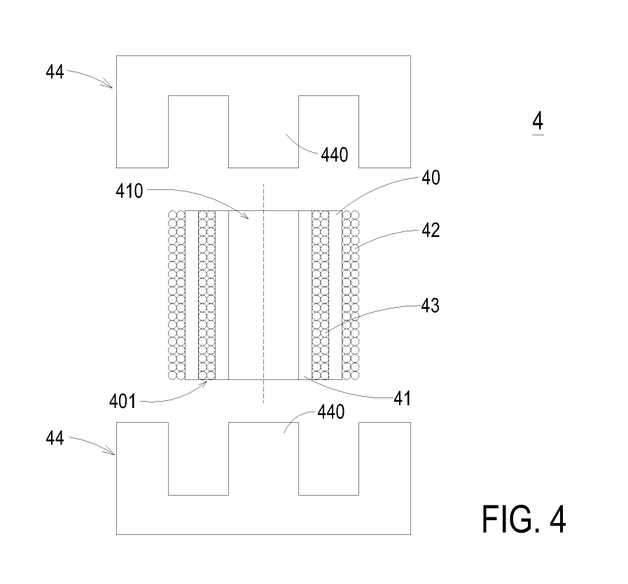

FIG. 4 is a schematic cross-sectional view illustrating a magnetic device according to a third embodiment of the present invention. In this embodiment, the magnetic device 4 has a plurality of thermally-conductive bobbins, so that the operating performance of the magnetic device is further enhanced. As shown in FIG. 4, the magnetic device 4 includes a first thermally-conductive bobbin 40, a second thermally-conductive bobbin 41, a first winding coil 42, a second winding coil 43, and a magnetic core assembly 44. The configurations of the first winding coil 42 and the second winding coil 43 are similar to those of the above embodiments, and are not redundantly described herein. In addition, the first thermally-conductive bobbin 40 has a first channel 401, and the second thermally-conductive bobbin 41 has a second channel 410. The first winding coil 42 is wound around the first thermally-conductive bobbin 40. The second winding coil 43 is wound around the second thermally-conductive bobbin 41. Moreover, the diameter of the combination of the second thermally-conductive bobbin 41 and the second winding coil 43 is substantially equal to the diameter of the first channel 401. Consequently, the combination of the second thermally-conductive bobbin 41 and the second winding coil 43 is tightly accommodated within the first channel 401 of the first thermally-conductive bobbin 40.

In this embodiment, the magnetic core assembly 44 is an EE-type magnetic core assembly. The magnetic core assembly 44 includes two E cores, wherein each E core includes a middle post 440 and two lateral posts. After the first thermally-conductive bobbin 40 with the first winding coil 42 and the second thermally-conductive bobbin 41 with the second winding coil 43 are combined together, the middle posts 440 of the magnetic core assembly 44 are inserted into the second channel 410 of the second thermally-conductive bobbin 41. Consequently, the magnetic core assembly 44 is at least partially embedded within the second channel 410 of the second thermally-conductive bobbin 41. The resulting structure of the assembled magnetic device 4 is shown in FIG. 4. Of course, the magnetic core assembly 44 is not limited to the EE-type magnetic core assembly. It is noted that numerous modifications and alterations of the magnetic core assembly 44 may be made while retaining the teachings of the invention.

In such way, the heat from the first winding coil 42 and the outer surface of the second coil 43 may be dissipated away through the first thermally-conductive bobbin 40, and the heat from the inner surface of the second coil 43 may be dissipated away through the second thermally-conductive bobbin 41. In other words, the uses of the first thermally-conductive bobbin 40 and the second thermally-conductive bobbin 41 can enhance the heat-dissipating efficacy and operating performance of the magnetic device 4.

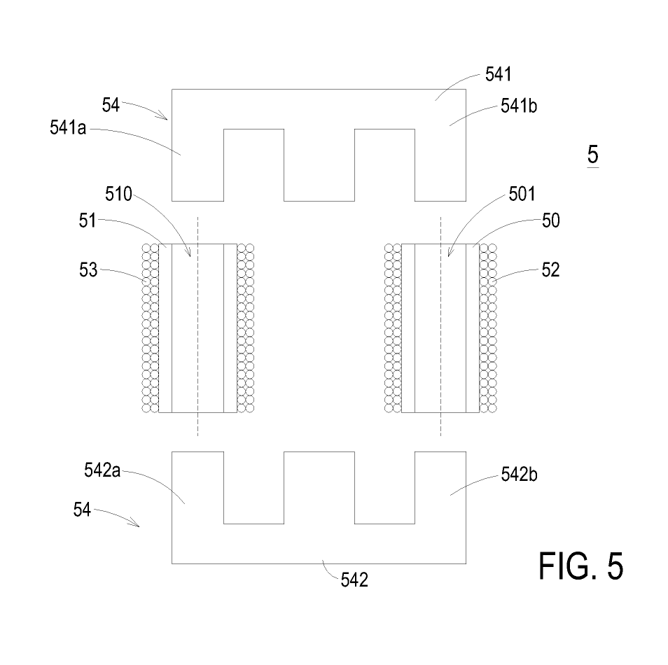

FIG. 5 is a schematic cross-sectional view illustrating a magnetic device according to a fourth embodiment of the present invention. In this embodiment, the magnetic device 5 also has a plurality of thermally-conductive bobbins. As shown in FIG. 5, the magnetic device 5 includes a first thermally-conductive bobbin 50, a second thermally-conductive bobbin 51, a first winding coil 52, a second winding coil 53, and a magnetic core assembly 54. In addition, the first thermally-conductive bobbin 50 has a first channel 501, and the second thermally-conductive bobbin 51 has a second channel 510. The configurations of the first thermally-conductive bobbin 50, the second thermally-conductive bobbin 51, the first winding coil 52 and the second winding coil 53 are similar to those of the above embodiments, and are not redundantly described herein. In this embodiment, the first thermally-conductive bobbin 50 and the second thermally-conductive bobbin 51 are arranged in a side-by-side manner. Moreover, the magnetic core assembly 54 includes a first magnetic core 541 and a second magnetic core 542. The first magnetic core 541 includes two magnetic parts 541a and 541b, and the second magnetic core 542 includes two magnetic parts 542a and 542b. For assembling the magnetic device 5, the first winding coil 52 and the second winding coil 53 are firstly wound around the first thermally-conductive bobbin 50 and the second thermally-conductive bobbin 51, respectively. Then, the magnetic parts 541b and 542b are embedded within the first channel 501, and the magnetic parts 541a and 542a are embedded within the second channel 510. Under this circumstance, the first thermally-conductive bobbin 50 and the second thermally-conductive bobbin 51 are arranged in a side-by-side manner. Consequently, the heat-dissipating efficacy and operating performance of the magnetic device 5 are both enhanced.

From the above embodiments, the magnetic device includes one or more thermally-conductive bobbins. For example, the magnetic device may have three, four or five thermally-conductive bobbins. Depending on the number of the thermally-conductive bobbins, the configurations of the magnetic core assembly are correspondingly adjusted. It is noted that numerous modifications and alterations of the magnetic core assembly may be made while retaining the teachings of the invention.

From the above description, the present invention provides a magnetic device with a thermally-conductive bobbin. The thermally-conductive bobbin is effective to dissipate the heat from the inner surfaces of the winding coil and the magnetic core assembly. Consequently, the operating temperature of the magnetic device is largely reduced. When compared with the conventional magnetic device having the external heat-dissipating plate, the magnetic device of the present invention has enhanced operating performance, better reliability and longer use life. Due to the thermally-conductive bobbin, the magnetic device of the present invention has reduced operating temperature, increased turns of winding coil, and enhanced operating performance. In addition, the overall volume of the magnetic device of the present invention is smaller, and the space utilization is enhanced. Moreover, since the heat-dissipating plate used in the conventional magnetic device may be omitted, the material cost of the present magnetic device is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic device, comprising:
a thermally-conductive bobbin having a winding section; and
a winding coil wound around said winding section, wherein the heat generated from said winding coil is dissipated away through said thermally-conductive bobbin.

2. The magnetic device according to claim 1, further comprising a magnetic core assembly, wherein said magnetic core assembly is at least partially embedded within a channel of said thermally-conductive bobbin.

3. The magnetic device according to claim 1, wherein said thermally-conductive bobbin has a non-seamless ring-shape.

4. The magnetic device according to claim 1, wherein said thermally-conductive bobbin is formed by at least two parts having corresponding profiles with each other.

5. The magnetic device according to claim 1, wherein said thermally-conductive bobbin further comprises a heat-dissipating plate, wherein said heat-dissipating plate is fixed on an inner wall of said thermally-conductive bobbin.

6. The magnetic device according to claim 1, further comprising an insulating medium formed on a surface of said thermally-conductive bobbin.

7. The magnetic device according to claim 1, further comprising an insulating medium arranged between said thermally-conductive bobbin and said winding coil.

8. The magnetic device according to claim 1, further comprising an insulating medium formed on a surface of said winding coil.

9. The magnetic device according to claim 1, further comprising a fixing structure, which is extended from said thermally-conductive bobbin, wherein through said fixing structure, said magnetic device is fixed on a system board.

10. The magnetic device according to claim 1, wherein a thermal conductivity of said thermally-conductive bobbin is 10 W/m×K or higher than 10 W/m×K.

11. A magnetic device, comprising:
a first thermally-conductive bobbin having a first channel;
a first winding coil wound around said first thermally-conductive bobbin;
a second thermally-conductive bobbin having a second channel; and
a second winding coil wound around said second thermally-conductive bobbin.

12. The magnetic device according to claim 11, further comprising a magnetic core assembly, wherein said second thermally-conductive bobbin is accommodated within said first channel of said first thermally-conductive bobbin, and said magnetic core assembly is at least partially embedded within said second channel of said second thermally-conductive bobbin.

13. The magnetic device according to claim 11, further comprising a magnetic core assembly, wherein said first thermally-conductive bobbin and said second thermally-conductive bobbin are arranged in a side-by-side manner, wherein a first part of said magnetic core assembly is at least partially embedded within said first channel of said first thermally-conductive bobbin, and a second part of said magnetic core assembly is at least partially embedded within said second channel of said second thermally-conductive bobbin.

14. The magnetic device according to claim 11, wherein a thermal conductivity of said first thermally-conductive bobbin or said second thermally-conductive bobbin is 10 W/m×K or higher than 10 W/m×K.

15. The magnetic device according to claim 11, wherein said first thermally-conductive bobbin or said second thermally-conductive bobbin has a non-seamless ring-shape.

16. The magnetic device according to claim 11, wherein said first thermally-conductive bobbin or said second thermally-conductive bobbin is formed by at least two parts having corresponding profiles with each other.

17. The magnetic device according to claim 11, further comprises a heat-dissipating plate, wherein said heat-dissipating plate is fixed on an inner wall of said first thermally-conductive bobbin or said second thermally-conductive bobbin.

18. The magnetic device according to claim 11, further comprising an insulating medium formed between said first thermally-conductive bobbin and said first winding coil or between said second thermally-conductive bobbin and said second winding coil.

19. The magnetic device according to claim 11, further comprising a fixing structure, which is extended from said first thermally-conductive bobbin or said second thermally-conductive bobbin, wherein through said fixing structure, said magnetic device is fixed on a system board.
